(19) United States
(12) Patent Application Publication
(10) Pub. No.: US 2007/0172289 A1
(43) Pub. Date: Jul. 26, 2007

(54) PAPER COMPARTMENT COVER FOR PRINTER

(75) Inventor: Carl Wesley Robinson, Charlotte, NC (US)

Correspondence Address: CONNOLLY BOVE LODGE & HUTZ LLP, P.O. BOX 2207, WILMINGTON, DE, 19899-2207, US

(73) Assignee: XAC AUTOMATION CORP., Hsinchu (TW)

(21) Appl. No.: 11/307,058

(22) Filed: Jan. 20, 2006

(51) Int. Cl. B41J 15/00

(52) U.S. Cl. 400/613

(57) ABSTRACT

A paper compartment cover can be unlocked to load a printer with a paper roll. A top cover is pivotally mounted on a flexible arm, and carries a platen in simple round journals with an opening for the snap-in assembly of the platen in the top cover. A lever shaft is also carried by the top cover in elongated holes so that it can move along the longitudinal direction of the elongated holes. On each side of the lever shaft, slider blocks are held in a manner enabling each of the slider blocks to linearly slide along a rib of the top cover. A lever is mounted on the shaft and, together with a return spring, provides a means for causing the linear motion of the lever shaft and the slider blocks. After the lever is lifted, the slider blocks are pushed against fixed ramps on a housing. Subsequently, the reacting force on the ramps unlocks the top cover from the housing.

### BACKGROUND OF THE INVENTION

1. Field of the Invention

The present invention relates to a paper compartment cover for a printer, and more particularly, to a cover for unlocking a paper compartment of a Point of Sale (POS) terminal.

2. Description of the Related Art

POS terminals of the type typically used by merchants permit holders of charge cards, credit cards, debit cards, and the like to make electronic payments for services and merchandise quickly and easily. With the advent of stored value cards and other smart card schemes, the use of POS terminals in some form is likely to increase dramatically over the next few decades. Indeed, as the feature set of POS terminals and associated peripheral devices such as PIN entry devices/terminals increases, the use of POS terminals may largely supplant or even replace the use of cash and checks in many contexts.

Thermal printers for printing information on paper rolls are commonly used with POS terminals, and the ability to easily load and replace paper rolls in such printers is particularly desirable. Therefore, for a thermal printer with the feature of a drop-in paper roll for easy operation, the design of the paper compartment cover and the means provided to the user for easy opening are very important to the success of the product. In order to have the feature of a drop-in paper roll, the platen of the thermal printer mechanism is carried by the paper compartment cover such that no threading of the paper into the mechanism is required. However, such design is faced with two basic problems.

The first troublesome task is how to design the paper compartment cover to carry the roller such that the opening of the cover is able to remove the platen from the thermal printer mechanism. If the thermal printer mechanism is designed to allow for the removal of the platen in a motion which has a single arc or circle trajectory, the solution seems good but very limited in that the location of the pivot of the paper compartment cover is dictated by the design of the thermal printer mechanism. If the thermal printer mechanism is designed with a platen removal motion that is something other than a single arc of a circle, the design of the paper compartment cover provides a way to allow the required platen motion during the opening of the cover. U.S. Pat. No. 6,646,565 proposed a solution in which the paper compartment cover supports the platen shaft in elongated holes such that it can move relative to the paper cover during the opening of the paper compartment cover.

The second basic problem for the paper compartment cover design is to allow for the effortless opening of the paper cover by the user. It is desirable to have a lever on the paper compartment cover itself such that the user pulls the lever and the cover is released from the detent of the thermal printer mechanism acting on the platen. Once released, the user continues the opening motion of the paper compartment cover while grasping the lever. This produces a very user-friendly and natural method of opening the paper cover. However, most of current POS terminals cannot solve the two problems at one tome.

As a result, there is a need for a less expensive, more effortless technique for easily loading and replacing paper rolls in the POS terminals.

### SUMMARY OF THE INVENTION

An objective of the present invention is to provide a paper compartment cover for the thermal or inkjet printer of a POS terminal. A user just lifts an opening level with one hand so as to release the whole paper compartment cover from the detent of a chassis. Such a design makes it easier to load and unload paper rolls used in the thermal printer of a POS terminal.

To achieve the objective, the present invention discloses a paper compartment cover for a printer. A top cover is pivotally mounted on a flexible arm, and carries a platen in simple round journals with an opening for the snap-in assembly of the platen in the top cover. A lever shaft is also carried by the top cover in elongated holes so that it can move along the longitudinal direction of the elongated holes. On each side of the lever shaft, slider blocks are held in a manner enabling each of the slider blocks to linearly slide along a rib of the top cover. A lever is mounted on the shaft and, together with a return spring, provides a means for causing the linear motion of the lever shaft and the slider blocks. After the lever is lifted, the slider blocks are pushed against fixed ramps on a housing. Subsequently, the reacting force on the ramps unlocks the top cover from the housing.

### BRIEF DESCRIPTION OF THE DRAWINGS

The invention will be described according to the appended drawings in which:

FIG. 1 is a perspective diagram of a POS terminal in accordance with the present invention;

FIG. 2 is an exploded diagram of the paper compartment cover of the thermal printer in FIG. 1;

FIG. 3 is a perspective diagram of the assembly of the top cover and the platen in FIG. 1;

FIG. 4 is another perspective diagram of the assembly of the top cover and the platen in FIG. 1;

FIG. 5 is another perspective diagram of the POS terminal in FIG. 1;

FIG. 6 illustrates the lift of the lever resulting in engagements between the slider blocks and the ramps in the POS terminal; and

FIG. 7 is a side view illustrating the top cover of the POS terminal in a locked state.

### PREFERRED EMBODIMENT OF THE PRESENT INVENTION

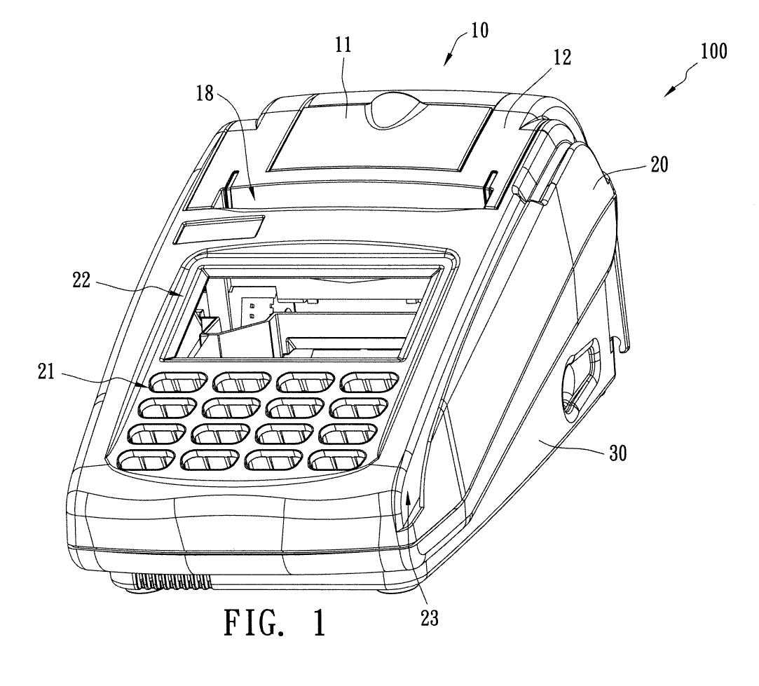

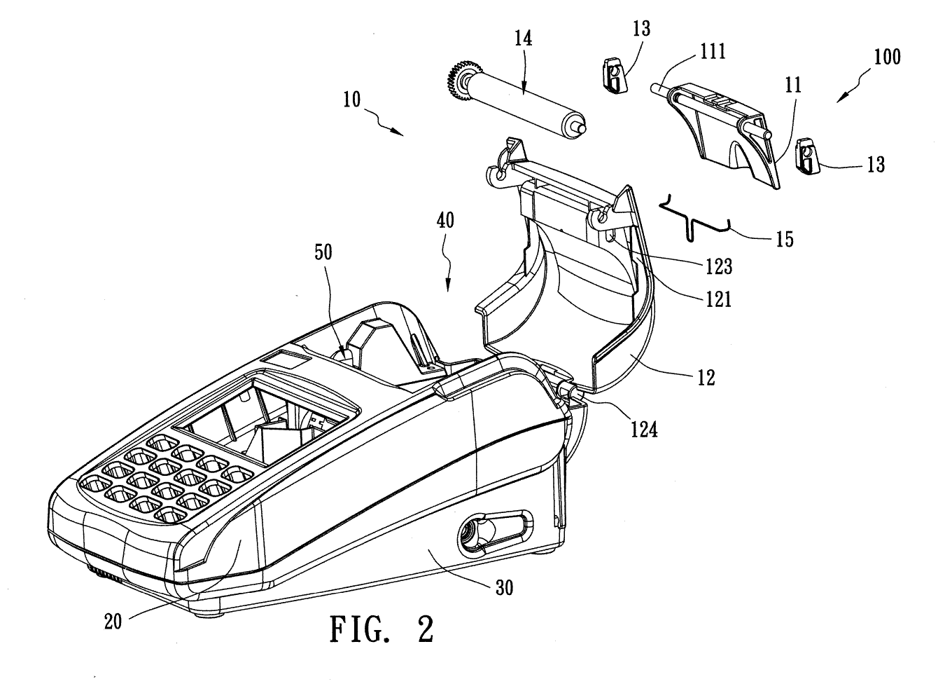

FIG. 1 is a perspective diagram of a POS terminal in accordance with the present invention, and FIG. 2 is an exploded diagram of the paper compartment cover of the thermal printer in FIG. 1. A POS terminal 100 comprises a paper compartment cover 10, an upper housing 20 and a lower housing 30. A user can pull a lever 11 to release a top cover 12 of the paper compartment cover 10 from a thermal printer 50 located in the upper housing 20 to load and unload a paper roll (not shown). A printed sheet of paper with transaction records is transferred to a slot 18 for the user to tear it off. There is a display area 22 and a keypad area 21 disposed on the upper housing 20; hence, the user can see prompt information and key in some data to the POS terminal 100. Also, one side of the upper housing 20 provides a hollow slide groove 23 to enable swiping of a card through a magnetic head (not shown).

When the top cover 12 is opened and rotates around its pivot 124, a paper roll compartment 40 appears. A platen 14 is carried by the top cover 12, and a lever shaft 111 is also carried by the top cover 12 in elongated holes 123 so that it can move along the longitudinal direction of the elongated holes 123. On each end of the lever shaft 111, slider blocks 13 are located; hence, they can move together with the lever shaft 111. The lever 111 is mounted on the lever shaft 111 and, together with a return spring 15, provides a means for causing the forward and rearward motion of the lever shaft 111 relative to the top cover 12. The return spring 15 encircles the lever shaft 111.

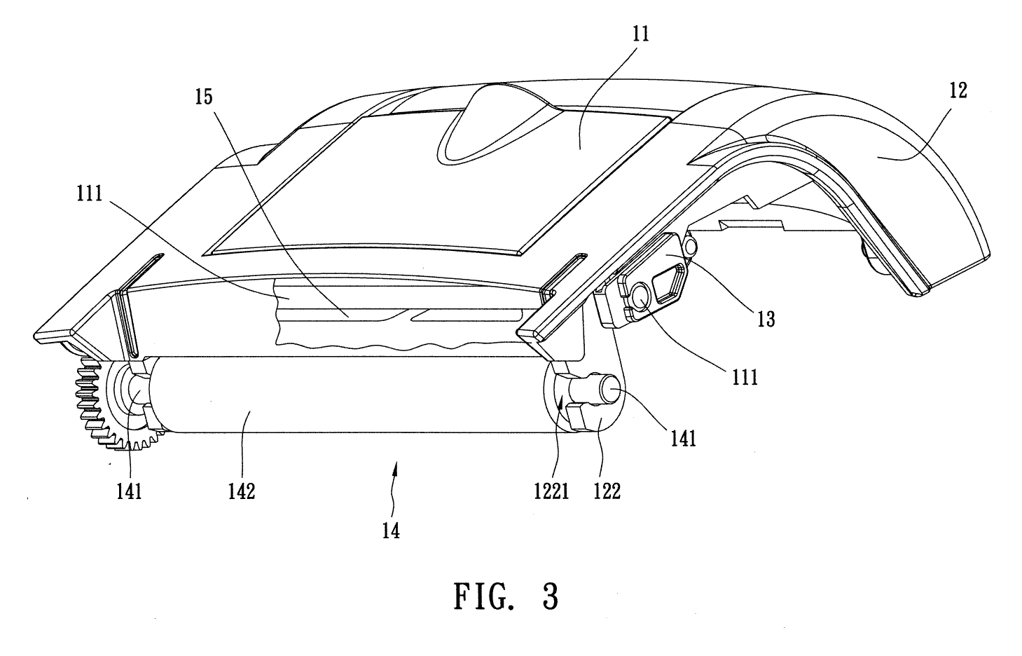

As shown in FIG. 3, the top cover 12 carries the roller shaft 141 of the platen 14 in simple round journals 122 with an opening 1221 for the snap-in assembly of the platen 14 in the top cover 12. A platen roller 142 is disposed around the roller shaft 141 for feeding the thermal printer 50 with roll paper. The return spring 15 is a torque spring whose middle portion forces itself against the shell of the top cover 12 so that it can apply torque to pull the lever 11 close to the top cover 12.

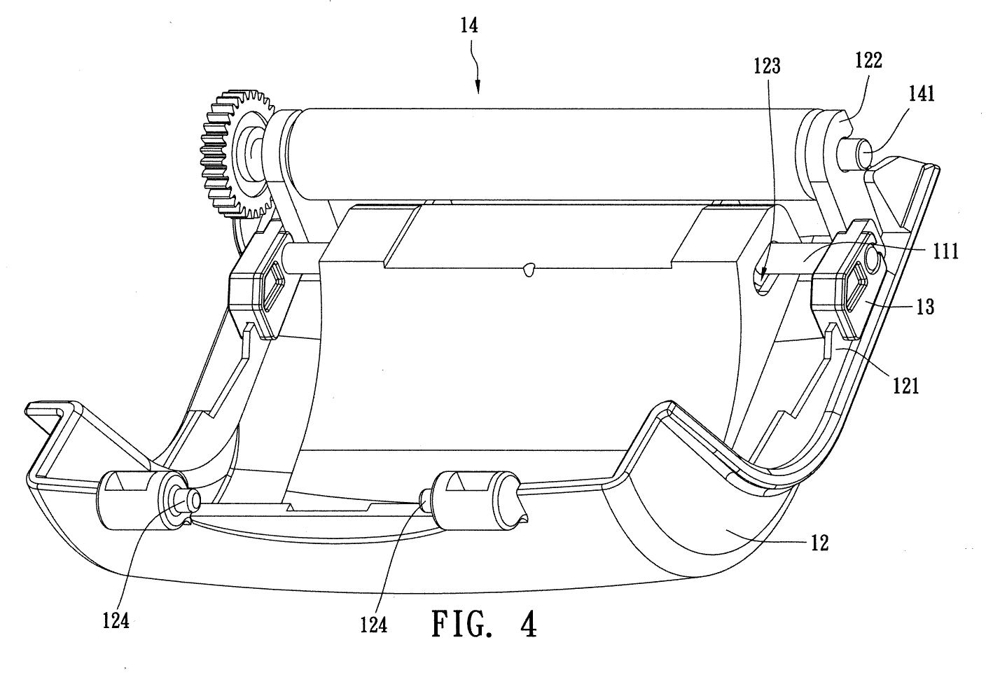

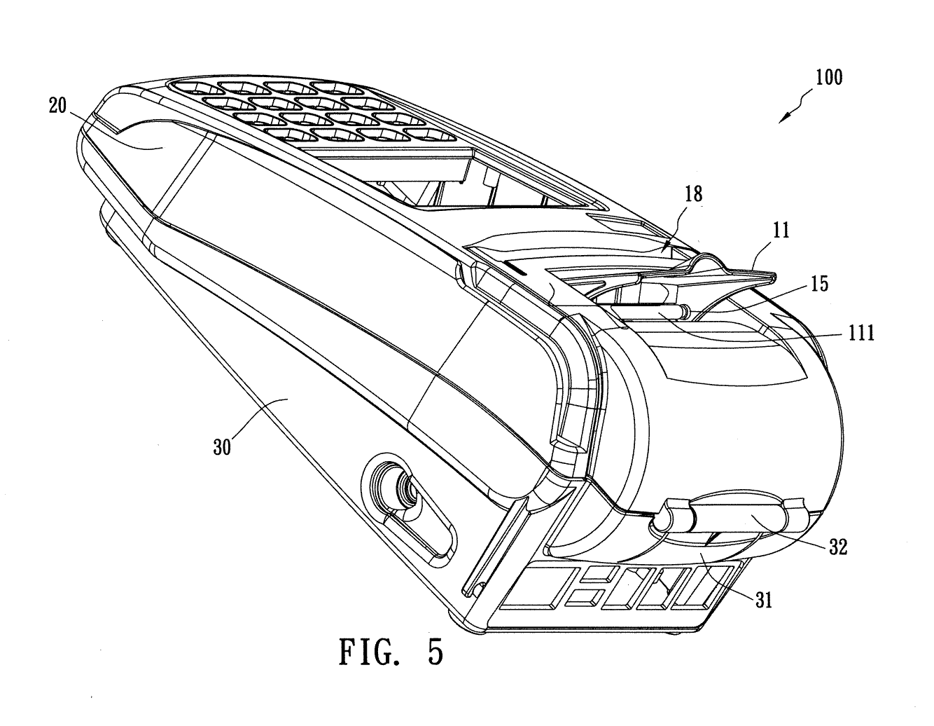

Referring to FIG. 4, each of the slider blocks 13 is mounted on a guiding rib 121 of the top cover 12. The lever shaft 111 is carried by the top cover 12 in the elongated holes 123 so that it can only move along the longitudinal direction of the elongated holes 123 parallel to the guiding direction of the ribs 121. The pivots 124 can be snapped into the holding part 32 of a flexible arm 31 (shown in FIG. 5).

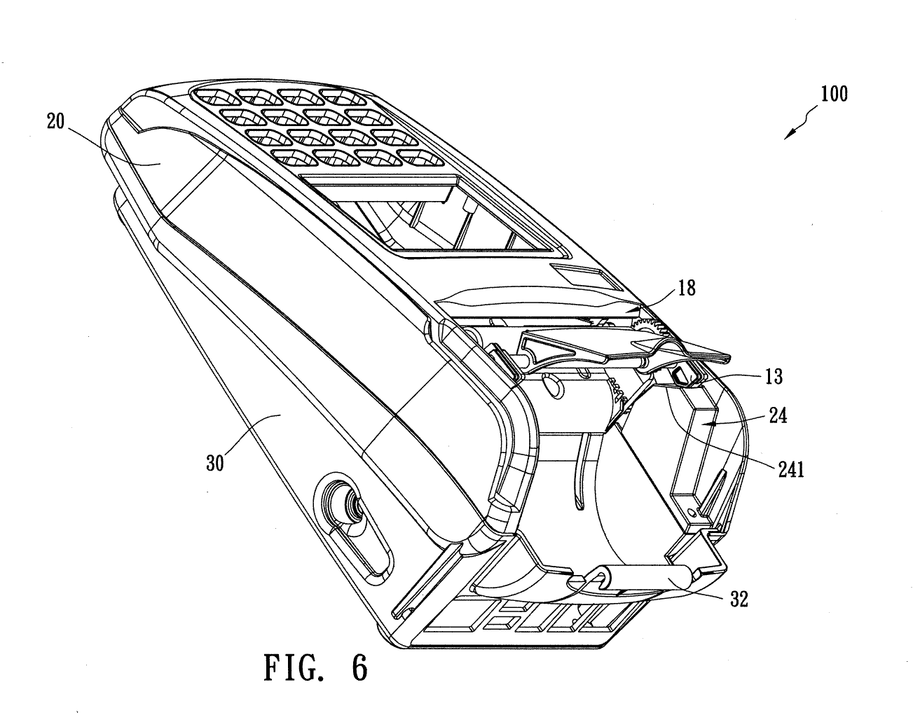

FIG. 5 illustrates that the lever 11 is turned around the lever shaft 111. When the lever 11 rotates over a specific angle, the slider blocks 13 are pushed against the fixed ramps 241 of shoulders 24 on the upper housing 20, as shown in FIG. 6. FIG. 6 especially shows that slider block 13 collides with the ramp 241 when the top cover 12 is removed. Simultaneously, the ramps 241 apply a reacting force to the slider blocks 13. Subsequently, the reacting force causes the top cover 12 pivotally mounted on the flexible arm 31 to move slightly toward the slot 18 because the flexible arm 31 can be elastically bent.

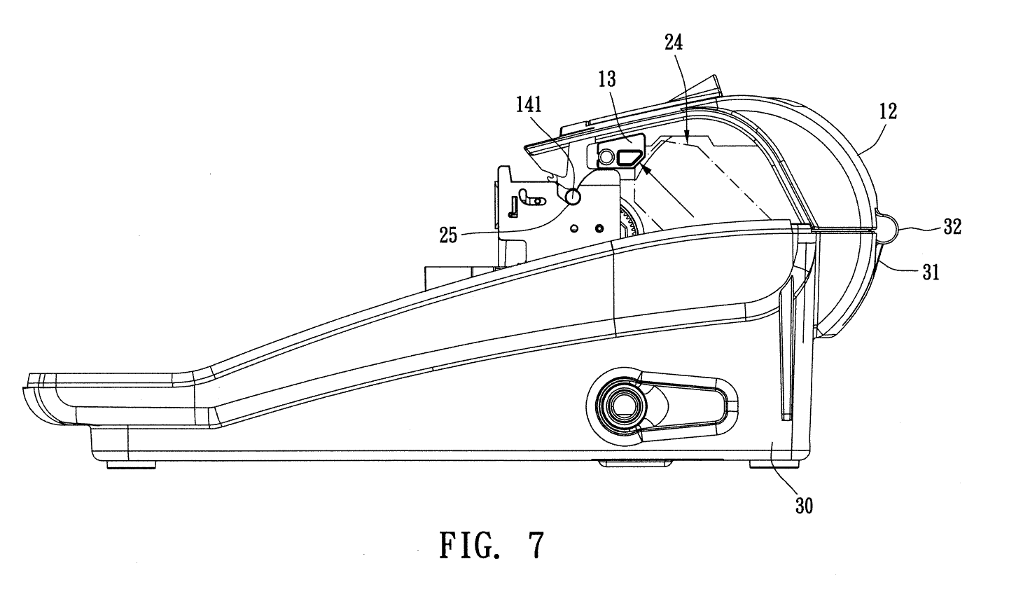

FIG. 7 is a side view illustrating the top cover of the POS terminal in a locked state after the upper housing 20 is removed. The top cover 12 is locked through the engagement between the roller shaft 141 and snap-in openings 25. When the lever 11 is lifted, the shoulder 24 applies the reacting force F to the slider block 13 on the top cover 12. If the reacting force F is sufficient to overcome the holding force of the snap-in openings 25 acting on the roller shaft 141, the roller shaft 141 is released from the snap-in openings 25. That is, the whole top cover 12 is successfully opened.

The above-described embodiments of the present invention are intended to be illustrative only. Numerous alternative embodiments may be devised by persons skilled in the art without departing from the scope of the following claims.

What is claimed as new and desired to be protected by Letters Patent of the United States is:

1. A paper compartment cover locked with a housing for a printer, comprising:
a flexible arm having one end fixed to the housing;
a top cover pivoted on the flexible arm and locked with the housing;
a lever shaft supported on the top cover to slide in relation to the top cover; and
a lever pivotally mounted on the lever shaft;
wherein the flexible arm is bent and the top cover is unlocked from the housing when a sliding movement of the lever shaft interferes with the housing.

2. The paper compartment cover of claim 1, further comprising a return spring encircling the lever shaft to force the lever close to the top cover.

3. The paper compartment cover of claim 1, wherein the lever shaft is carried by the top cover in elongated holes so that the lever shaft can move along a longitudinal direction of the elongated holes.

4. The paper compartment cover of claim 1, further comprising slider blocks held on ends of the lever shaft and linearly sliding on the top cover.

5. The paper compartment cover of claim 4, wherein each of the slider blocks is mounted on a rib disposed on the top cover and slides along the rib.

6. The paper compartment cover of claim 4, wherein the slider blocks interfere with the housing when the lever is turned around the lever shaft.

7. The paper compartment cover of claim 6, wherein the interference between the slider blocks and the housing causes the flexible arm to be bent toward the lever so that the top cover is unlocked from the housing.

8. The paper compartment cover of claim 1, further comprising a platen carried by the top cover in round journals, each with an opening, wherein the platen is snapped into the round journals through the openings.

9. The paper compartment cover of claim 8, wherein the platen includes a roller shaft and a platen roller surrounding the roller shaft, and the roller shaft is snapped into the round journals.

10. The paper compartment cover of claim 9, wherein the roller shaft is held by snap-in openings on the housing in a locked state for the paper compartment cover.
